(19) United States
(12) Patent Application Publication
(10) Pub. No.: US 2020/0391502 A1
(43) Pub. Date: Dec. 17, 2020

(54) INK SUPPLYING DEVICE FOR PRINTER AND INK SUPPLYING METHOD

(71) Applicant: I. MER CO., LTD., Kyoto-shi, Kyoto (JP)

(72) Inventor: Masayuki IZUME, Kyoto-shi (JP)

(21) Appl. No.: 16/762,951

(22) PCT Filed: Nov. 14, 2018
(86) PCT No.: PCT/JP2018/042075

§ 371 Date: May 11, 2020

(30) Foreign Application Priority Data
Dec. 7, 2017 (JP) 2017-234770

(51) Int. Cl. B41F 31/14; B41F 31/10; B41F 31/36; B41F 31/26

(52) U.S. Cl. CPC B41F 31/14; B41F 31/26; B41F 31/36; B41F 31/10

(57) ABSTRACT

An ink feeding device of a printing machine advances and retracts individual ductor rollers pneumatically between an ink fountain roller and an ink transfer roller. Along a fixed shaft, the individual ductor rollers are aligned, and the fixed shaft is provided with an air feeding pipe; electromagnetic valves for advancing the individual ductor rollers toward the ink fountain roller by the air from the air feeding pipe; and springs for retracting the individual ductor rollers toward the ink transfer roller. The controller makes the electromagnetic valves on in the order from a deep position to an inlet position along the air feeding pipe and advances the individual ductor rollers toward the ink fountain roller in this order.

### FIELD OF THE INVENTION

The present invention relates to an ink feeding device and an ink feeding method for a printing machine, in particular, to such an ink feeding device and an ink feeding method that plural individual ductor rollers advance and retract with shifted timings.

### BACKGROUND ART

In offset printing machines and letterpress printing machines, a ductor roller is provided between the ink fountain roller and an ink transfer roller and advances and retracts between the ink fountain roller and the ink transfer roller. In addition, when the ductor roller is divided into plural individual ductor rollers and when the individual ductor rollers advance and retract independently, then, the ink feeding amount is adjustable along the axial direction of the ink fountain roller (for example, Patent Document 1: JP5588651B). This reduces the unevenness of printing density along the axial direction of the ink fountain roller. The individual ductor rollers advance and retract by air pressure and springs; namely, from a shaft for the entire ductor roller, air pressure is applied to the individual ductor rollers to make them advance to the ink fountain roller. When the air pressure is eliminated, the individual ductor rollers retract toward the ink transfer roller by the spring force.

If the plural individual ductor rollers are operated at the same time, then a large amount of air is needed. Therefore, the plural individual ductor rollers are operated with shifted timings. In this specification, the individual ductor rollers are numbered as 1 at the inlet side of the air supplying pipe and the number increases at deeper positions of the pipe. According to Patent Document 1, the individual ductor rollers are operated in the order of the above number; namely, first, an individual ductor roller with number 1 is fed with air, next, an individual ductor roller with number 2 is fed, and then, the rollers are fed in the order of 3→4→5 . . . .

### PRIOR ART DOCUMENT

### Patent Document

Patent Document 1 JP5588651B

### SUMMARY OF THE INVENTION

### Problem to be Solved by the Invention

The inventor has noticed the pressure with which an individual ductor roller contacts the ink fountain roller (nip pressure) varies subtly and this causes the shift of printing density from a desired value. Further, the inventor has found, when changing air feeding order to the individual ductor rollers, the unevenness of the nip pressure may be reduced.

The object of the present invention is to reduce the unevenness of the nip pressure of the individual ductor rollers in ink feeding devices.

### Means for Solving the Problem

An ink feeding device for a printing machine according to the invention advances and retracts individual ductor rollers pneumatically between an ink fountain roller and an ink transfer roller, both of the printing machine.

The ink feeding device comprises a fixed shaft along which plural individual ductor rollers are aligned and is provided with an air feeding pipe for feeding air; plural electromagnetic valves provided for each of the individual ductor rollers and for making air-feeding from the air feeding pipe on in order to advance the individual ductor rollers toward the ink fountain roller; and plural springs provided for each of the individual ductor rollers and for retracting the individual ductor rollers toward the ink transfer roller; and

a controller for controlling the electromagnetic valves,

said controller is configured and programmed to make the electromagnetic valves on in the order from a deep position to an inlet position along the air feeding pipe and to advance the individual ductor rollers toward the ink fountain roller in this order.

An ink feeding method according to the invention advances and retracts individual ductor rollers pneumatically between an ink fountain roller and an ink transfer roller.

The method uses an ink feeding device comprising: a fixed shaft along which plural individual ductor rollers are aligned and is provided with an air feeding pipe for feeding air; plural electromagnetic valves provided for each of the individual ductor rollers and for making air-feeding from the air feeding pipe on in order to advance the individual ductor rollers toward the ink fountain roller; and plural springs provided for each of the individual ductor rollers and for retracting the individual ductor rollers toward the ink transfer roller; and

a controller for controlling the electromagnetic valves.

The method comprises making the electromagnetic valves on by said controller in the order from a deep position to an inlet position along the air feeding pipe, and advancing the individual ductor rollers toward the ink fountain roller in this order.

With respect to an example of six individual ductor rollers, the invention (FIG. 3) and Patent Document 1 (FIG. 4) are compared. According to the invention, in the order from a deep position, preferably from the deepest position, to the inlet position along the air feeding pipe, the individual ductor rollers are operated. During when air is fed for operating the sixth individual ductor roller, the fifth individual ductor roller may be made on (operated). Then, air flows in the air feeding pipe toward the fifth individual ductor roller, and dynamic pressure is generated. Therefore, in the vicinity of the first to fourth individual ductor rollers, the static pressure is reduced in the air feeding pipe. However, in the vicinity of the sixth individual ductor roller, the pressure remains almost constant, and therefore, the pressure by which the sixth individual ductor roller advances toward the ink fountain roller remains almost constant.

According to the conventional example in FIG. 4, the individual ductor rollers advance in the order from the inlet to deeper positions along the air feeding pipe. During when the first individual ductor roller is advanced (on), if the second individual ductor roller is made advanced, then air flows in the vicinity of the first individual ductor roller toward the second individual ductor roller, and the static pressure is reduced in the air feeding pipe. Therefore, the air pressure by which the first individual ductor roller advances is reduced, and as a result, the nip pressure is also reduced. When the nip pressure is decreased, the ink amount taken out of the ink fountain roller is reduced, and the printing density is reduced.

According to the invention, when plural individual ductor rollers assume the “on” state simultaneously, the pressure decrease regarding the individual ductor roller operated from an earlier timing is made smaller, and therefore the decrease in the nip pressure can also be reduced. Therefore, the variation in printing density is reduced.

### BRIEF DESCRIPTION OF THE DRAWINGS

FIG. 1 A view indicating an ink feeding device according to an embodiment, an ink fountain roller, and an ink transfer roller.

FIG. 2 A cross-sectional view of the ductor roller.

FIG. 3 A diagram indicating an air feeding order to individual ductor rollers according to the embodiment.

FIG. 4 A diagram indicating a conventional air feeding order to individual ductor rollers (Patent Document 1).

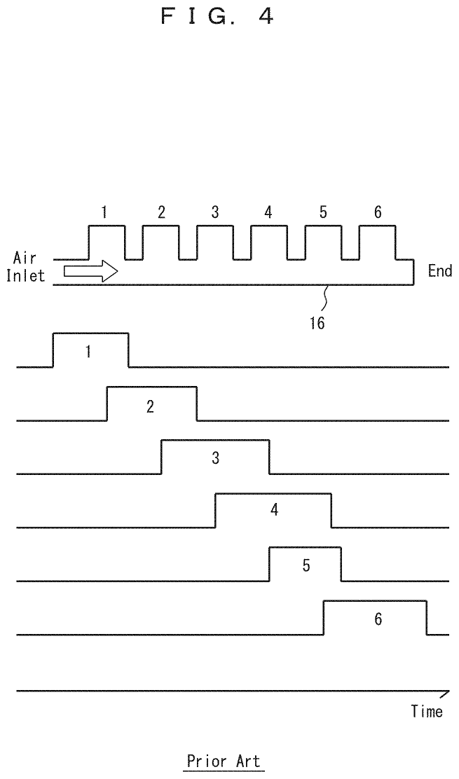

FIG. 5 A diagram indicating an air feeding order to individual ductor rollers according to a modification.

### DESCRIPTION FOR CARRYING OUT THE INVENTION

The best embodiment for carrying out the invention will be described.

### Embodiment

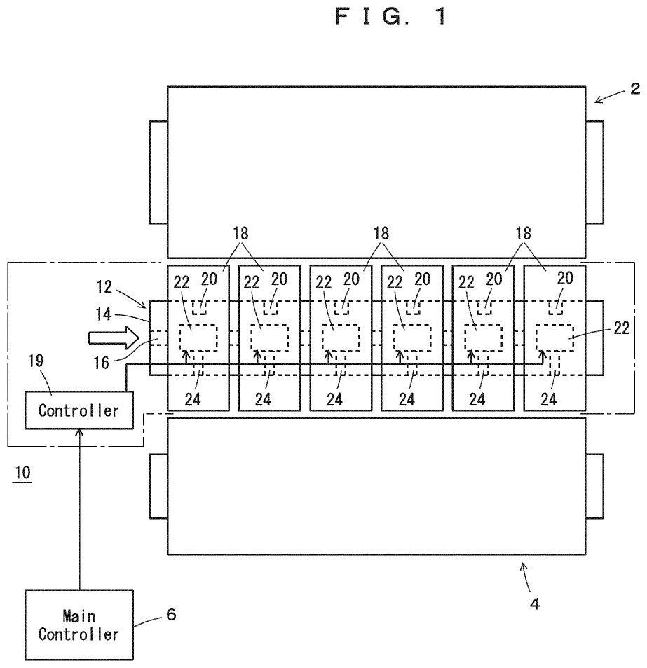

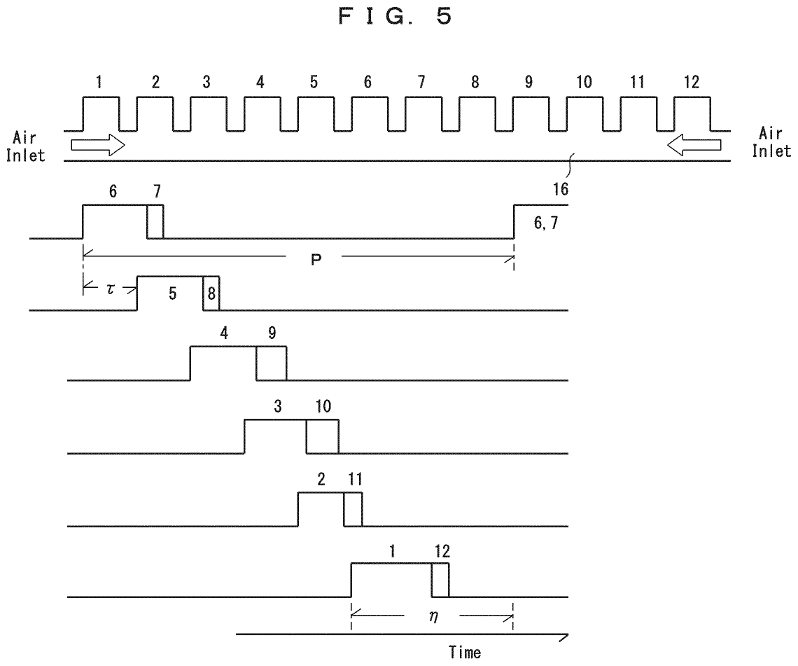

FIGS. 1 to 3 indicate an ink feeding device 10 according to the embodiment and its operation, and FIG. 5 indicates a modified operation. In FIG. 1, the ink fountain roller 2 forms an ink fountain between an unshown ink fountain plate and supplies the ink from the ink fountain to ductor roller 12. The ink transfer roller 4 receives the ink from the ductor roller 12 and feeds it toward the unshown plate cylinder. In addition, at the downstream of the ink transfer roller 4 in FIG. 1, there are other unshown ink transfer rollers before the plate cylinder. Further, indicated by 6 is an overall controller (main controller) for the printing machine. The printing machine may print on papers, cans, CD-ROMs, or other media.

The ink feeding device 10 comprises the ductor roller 12, its controller 19, and in addition, an unshown compressed air source (for example, an air compressor). The ductor roller 12 is provided with a fixed shaft 14; in parallel with the axial direction of the fixed shaft 14, an air feeding pipe 16 is provided, and plural individual ductor rollers 18 are provided along the axial direction of the fixed shaft 14. In FIGS. 1 to 3, six individual ductor rollers 18 are shown, and more or fewer rollers may be provided. In the fixed shaft 14, there are provided, for each of the individual ductor rollers 18, a piston 20 advancing pneumatically, an electromagnetic valve 22 for making the piston 20 on (advanced), and a pressing piece 24 for retracting the individual ductor roller 18 toward the ink transfer roller 4.

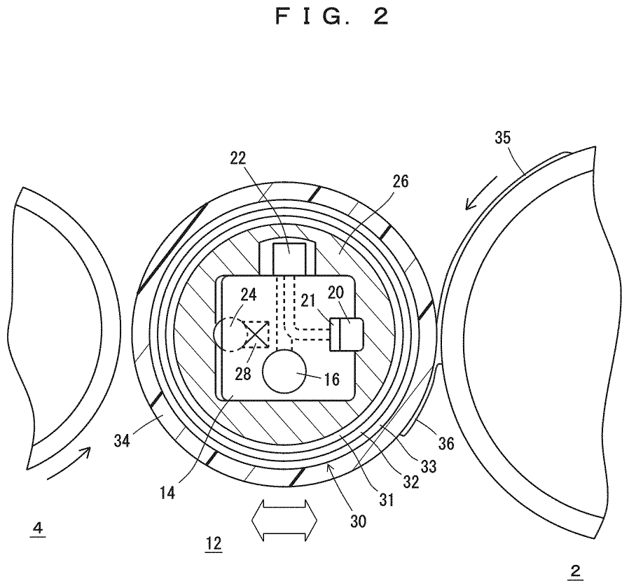

FIG. 2 shows the cross-section of the ductor roller 12; an association member 26 associated with the fixed shaft 14 advances and retracts between the ink fountain roller 2 and the ink transfer roller 4. Here, FIG. 2 indicates members for one individual ductor roller 18. The piston 20 advances along a cylinder 21 and therefore, makes the association member 26 advance toward the ink fountain roller 2. Note that the air pressure from the cylinder 21 may be applied directly onto the association member 26 without the piston 20. The pressing piece 24, for example, in a ball-like shape, is biased toward the ink transfer roller 4 by a spring 28; when the air supply to the cylinder 21 is shut off, the association member 26 retracts toward the ink transfer roller 4 by the biasing force. In addition, the electromagnetic valve 22 switches the states of the cylinder 21 between an “on” state (air feeding) connected to the air feeding pipe 16 and an “off” state (evacuation) connected to outside and the valve is controlled by a controller 19 in FIG. 1.

On the circumferential face of the association member 26, a bearing 30 is attached; indicated by 31 is an inner race, 32 is a ball retainer, and 33 is an outer race. On the outer race 33, a resin ring 34 is attached and the association member 26 to the resin ring 34 constitute the individual ductor roller 18. In addition, indicated by 35, 36 in FIG. 2 are ink films; when an individual ductor roller 18 is pressed on the ink fountain roller 2, the ink film 36 is generated on the individual ductor roller 18. When the individual ductor roller 18 is in contact with the ink transfer roller 4, the ink in the ink film 36 is transferred onto the ink transfer roller 4 and then, to the plate cylinder, finally.

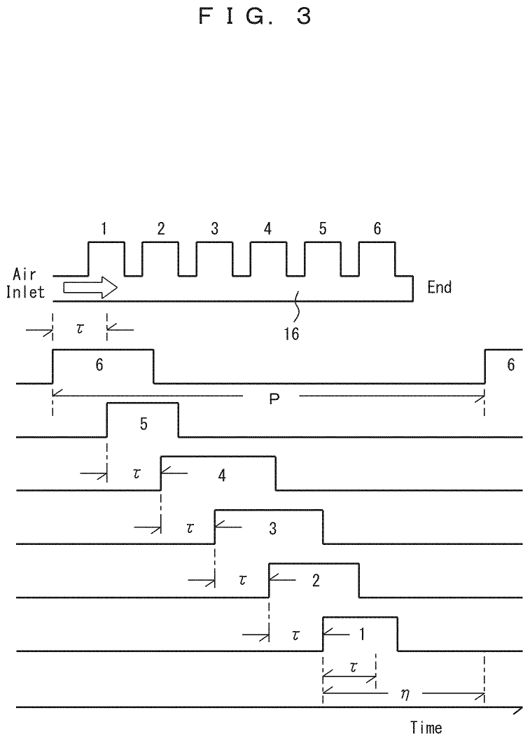

The operation of the embodiment is shown in FIG. 3. In the order from the inlet of the air feeding pipe 16 to the deepest position, the first to, for example, sixth individual ductor rollers are provided. The individual ductor rollers are made on in the order from the deepest number 6 to the number 1 at the inlet, preferably with a constant time lag τ. When on, from a corresponding electromagnetic valve, air is supplied to the corresponding cylinder. In FIG. 3, at most, three individual ductor rollers are on at the same time; however, it is arbitrary how many rollers are allowed on at the same time. Further, the time lag τ may not be constant. For example, the time lag between the timings when adjacent individual ductor rollers are made off is set constant, and the time lag τ between on-timings may be variable. Further, P represents a period for operating the six individual ductor rollers and is, for example, constant. The time interval η from when the first individual ductor roller is made on to when the sixth individual ductor roller is made on is set longer than τ and, for example, η is twice or more of τ.

During when the sixth individual ductor roller is on, if the fifth individual ductor roller is made on, air flows in the air feeding pipe 16 toward the fifth individual ductor roller, and the static pressure is decreased in the air feeding pipe along the first to the fourth individual ductor rollers. However, in the vicinity of the sixth individual ductor roller, no additional airflow is generated in the air feeding pipe, and therefore, the change in the static pressure is small. Therefore, the nip pressure with which the sixth individual ductor roller is pressed onto the ink fountain roller is kept almost constant. Of course, the amount of ink taken out by an individual ductor roller varies according to the nip pressure. Further, regarding other individual ductor rollers than the sixth roller, the same applies.

FIG. 5 indicates the operation according to a modification. Air is fed from both sides of the air feeding pipe, the individual ductor rollers are operated in the order from a pair of rollers at the center of the air feeding pipe to a pair of rollers at both inlets. In FIG. 5, among 12 individual ductor rollers, for example, the sixth and seventh individual ductor rollers at the center are first operated and the first and 12th individual ductor rollers at both ends are operated last. Two individual ductor rollers at symmetrical positions about the center are preferably made on at the same time. By the way, in FIG. 5, the on periods for the sixth and the fifth individual ductor rollers are shorter than those for the seventh and eighth individual ductor rollers; this is for easy drawing and has no meaning. Further, two individual ductor rollers symmetrical about the center, for example, the sixth and seventh, and the fifth and eighth, are preferably made on at the same time. Regarding other points, the modification is the same as the embodiment in FIG. 3; this modification also makes the decrease in the nip pressure smaller when two adjacent individual ductor rollers are on at the same time.

In the embodiment, the individual ductor rollers are operated in the order of (6→5→4→3→2→1)→pause (corresponding to η−τ)→(6→5→4→3→2→1) in the roller number. In addition, the individual ductor rollers may be divided into plural groups, such as (6,4,2) and (5,3,1) in the number, and they may be operated in the order of (6→4→2)→pause→(5→3→1)→pause→(6→4→2)→pause→(5→3→1) or the like. In this case, if the pause time is enough long, for example, if it is twice or more of 2τ so that the second and fifth individual ductor rollers do not operate simultaneously, the same results are achieved. In this case, there are two separated orders of (6→4→2) and (5→3→1), and in each order, the electromagnetic valves are operated from the deepest position to the inlet position. Therefore, this is within this invention.

A supplement is made regarding the order from a deep position to the inlet position. For example, the order comprising (6→5→4→3→2→1) can be decomposed to five pairs of adjacent timings of (6→5)<(5→4)<(4→3)<(3→2)<(2→1). Here the symbol “<” indicates after the left pair is executed, the right pair will be executed. Each pair is in the normal order when in the order from a deeper position to an inlet side position and is in the reverse order when in the order from an inlet side position to a deeper position. For example, (5→4) and (5→3) are in the normal order, and (4→5) and (3→5) are in the reverse order. When more than half of the pairs are in the normal order, the order from a deep position to the inlet position is satisfied. Preferably, when at least ⅔ of the pairs are in the normal order, the order from a deep position to the inlet position is satisfied. More preferably, when at least ¾ of the pairs are in the normal order, the order from a deep position to the inlet position is satisfied. Most preferably, when all of the pairs are in the normal order, the order from a deep position to the inlet position is satisfied.

### DESCRIPTION OF SYMBOLS

2 ink fountain roller
4 ink transfer roller
6 main controller
10 ink feeding device
12 ductor roller
14 fixed shaft
16 air feeding pipe
18 individual ductor roller
19 controller
20 piston
21 cylinder
22 electromagnetic valve
24 pressing piece
26 association member
28 spring
30 bearing
31 inner race
32 ball retainer
33 outer race
34 resin ring
35,36 ink film

What is claimed is:

1. An ink feeding device for a printing machine advancing and retracting individual ductor rollers pneumatically between an ink fountain roller and an ink transfer roller, both of the printing machine, comprising:
a fixed shaft along which plural individual ductor rollers are aligned and is provided with an air feeding pipe for feeding air; plural electromagnetic valves provided for each of the individual ductor rollers and for making air-feeding from the air feeding pipe on in order to advance the individual ductor rollers toward the ink fountain roller; and plural springs provided for each of the individual ductor rollers and for retracting the individual ductor rollers toward the ink transfer roller; and
a controller for controlling the electromagnetic valves,
wherein said controller is configured and programmed to make the electromagnetic valves on in the order from a deep position to an inlet position along the air feeding pipe and to advance the individual ductor rollers toward the ink fountain roller in this order.

2. An ink feeding method for a printing machine advancing and retracting individual ductor rollers pneumatically between an ink fountain roller and an ink transfer roller, both of the printing machine, using:
an ink feeding device comprising: a fixed shaft along which plural individual ductor rollers are aligned and is provided with an air feeding pipe for feeding air; plural electromagnetic valves provided for each of the individual ductor rollers and for making air-feeding from the air feeding pipe on in order to advance the individual ductor rollers toward the ink fountain roller; and plural springs provided for each of the individual ductor rollers and for retracting the individual ductor rollers toward the ink transfer roller; and
a controller for controlling the electromagnetic valves,
said method comprising making the electromagnetic valves on by said controller in the order from a deep position to an inlet position along the air feeding pipe, and advancing the individual ductor rollers toward the ink fountain roller in this order.
